(19) United States
(12) Patent Application Publication
(10) Pub. No.: US 2006/0034649 A1
(43) Pub. Date: Feb. 16, 2006

(54) Paper transfer unit and image forming apparatus employing the same

(75) Inventors: Dong-Hun Han, Suwon-si (KR); Myung-Bo Son, Anyang-si (KR); Yong-duk Lee, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/183,755

(22) Filed: Jul. 19, 2005

(30) Foreign Application Priority Data
Aug. 16, 2004 (KR) 2004-0064224

(51) Int. Cl. B41J 13/076; B41J 13/02; B41J 13/03

(52) U.S. Cl. 400/637; 400/641

(57) ABSTRACT

A paper transfer unit includes a pinch roller and a feed roller having a first outer portion, which defines a reference radius used to determine a paper transfer rate. A second outer portion is also provided having a substantially elastic rubber layer An elastic element elastically biases the pinch roller and the feed roller toward each other.

### CROSS-REFERENCE TO RELATED APPLICATIONS

This application claims the benefit of Korean Patent Application No. 10-2004-0064224, filed on Aug. 16, 2004, the entire disclosure of which is hereby incorporated by reference.

### BACKGROUND OF THE INVENTION

1. Field of the Invention

The present invention relates to a paper transfer unit and an image forming apparatus employing the same. More particularly, the present invention relates to a paper transfer unit in which a pair of rollers are rotatably engaged with each other to transfer paper and an image forming apparatus employing the same.

2. Description of the Related Art

FIG. 1 is a perspective view of a conventional paper transfer unit. A driving roller 1 is rotated by a motor (not shown) and a driven roller 2 contacts the driving roller 1. The driving roller 1 includes a metal shaft 1A combined with a cylindrical rubber roller 1B. An elastic element 3 pushes the driven roller 2 toward the driving roller 1. An outer surface of the driven roller 2 contacts an outer surface of the rubber roller 1B. The driving roller 1 and the driven roller 2 are rotatably engaged with each other. Paper P is transferred between the driving roller 1 and the driven roller 2.

When the paper transfer unit of FIG. 1 is employed in an image forming apparatus, such as a thermal image forming apparatus or an electrophotographic image forming apparatus, in which heat is generated during a printing process, a diameter of the rubber roller 1B changes in accordance with temperature differential. The paper transfer rate depends on a diameter D1 of the rubber roller 1B and a rotation angle θ (radian) of the driving roller 1. For example, if the paper transfer rate is equal to [θ×D½], when the diameter D1 of the rubber roller 1B changes, the paper transfer rate also changes. Therefore, achieving an accurate paper transfer rate is relatively difficult.

Accordingly, there is a need for an image forming apparatus that has a paper transfer unit which improves paper transfer rate accuracy by limiting the diameter variation of a feed roller.

### SUMMARY OF THE INVENTION

An aspect of the present invention is to solve at least the above problems and/or disadvantages and to provide at least the advantages described below. Accordingly, an aspect of the present invention is to provide a paper transfer unit that improves paper transfer accuracy by limiting the diameter variation of a feed roller and an image forming apparatus employing the same.

According to an aspect of the present invention, there is provided a paper transfer unit comprising a pinch roller and a feed roller having a first outer portion. The first outer portion defines a reference radius used to determine the rate of paper transfer rate. A second outer portion comprises a substantially elastic rubber layer arranged thereon. An elastic element elastically biases the pinch roller and the feed roller toward each other.

According to exemplary embodiments of the paper transfer unit, a diameter of the second outer portion may be greater than a diameter of the first outer portion. The elastic rubber layer may compress via the elastic element so that the pinch roller contacts the first outer portion. Preferably, a difference between the diameters of the first and second outer portions may be less than or equal to about 2 mm. A ceramic coating layer may be provided on the first outer portion.

According to another aspect of the present invention, there is provided an image forming apparatus comprising a paper transfer unit which transfers paper and a thermal printing head which applies heat to the paper to form images. A platen pressure presses the paper to the thermal printing head. The paper transferring unit comprises a pinch roller, a feed roller having a first outer portion, which defines a reference radius used to determine a paper transfer rate, and a second outer portion on which a substantially elastic rubber layer is arranged. An elastic element elastically biases the pinch roller and the feed roller toward each other.

The thermal printing head may rotate on the platen to move to a first position to face a first surface of the paper and to a second position to face a second surface of the paper.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a perspective view of a conventional paper transfer unit;

FIG. 2 is a perspective view of a paper transfer unit in accordance with an exemplary embodiment of the present invention;

FIG. 3 is a cross-sectional view of the paper transfer unit of FIG. 2;

FIG. 4 is a cross-sectional view of a paper transfer unit in accordance with another exemplary embodiment of the present invention;

FIG. 5 is a cross-sectional view of another example of the paper transfer unit of FIG. 4;

FIGS. 6 and 7 are configuration diagrams schematically illustrating an image forming apparatus according to an embodiment of the present invention;

FIGS. 8A through 8F are diagrams illustrating an image forming process of the image forming apparatus of FIGS. 6 and 7, according to an embodiment of the present invention;

FIG. 9 is a cross-sectional view of an example of paper used in the image forming apparatus of FIGS. 6 and 7;

FIG. 10 is schematic perspective view of an image forming apparatus disclosed in Korean Patent Application No. 2004-42504;

FIG. 11 is a cross-sectional view taken along line I-I′ of FIG. 10;

FIG. 12 is a exploded perspective view illustrating in detail a rotation structure of a thermal printing head (TPH); and

FIGS. 13A through 13I are diagrams illustrating rotation operations of the TPH.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

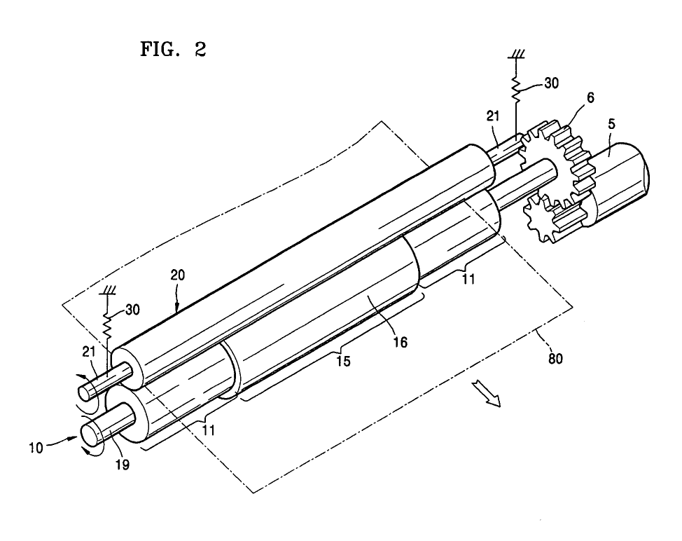

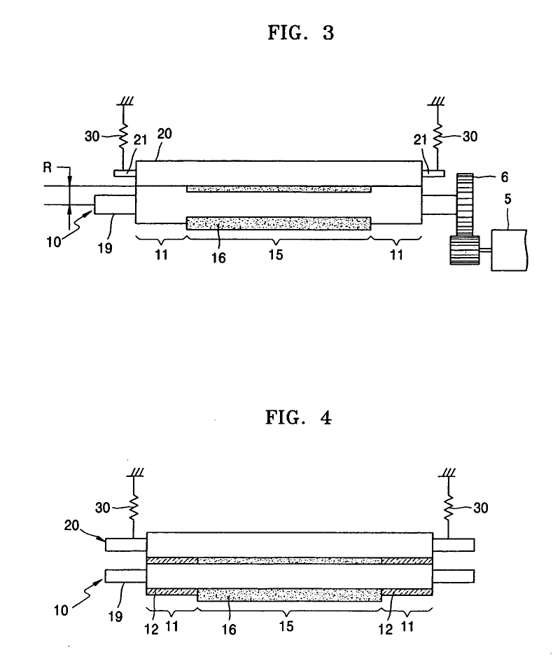

FIGS. 2 and 3 are a perspective view and a cross-sectional view of a paper transfer unit according to an exemplary embodiment of the present invention. Referring to FIGS. 2 and 3, a feed roller 10 engages with a pinch roller 20. An elastic element 30 biases the feed roller 10 and the pinch roller 20 toward each other for engagement. The elastic element 30 is preferably a compressive coil spring and pushes both ends 21 of the pinch roller 20 toward the feed roller 10. Driving power from driving roller 5 is delivered to the feed roller 10, for example, via a gear 6 combined to an end of the feed roller 10.

The feed roller 10 includes a first outer portion 11 and a second outer portion 15. The first outer portion 11 defines a reference radius used to determine the paper transfer rate and is formed as a substantially rigid body, for example, by cut processing a metal shaft 19. Accordingly, a diameter of the first outer portion 11 does not change in accordance with temperature changes. An elastic rubber layer 16 is provided on the second outer portion 5. The elastic rubber layer 16 is formed by preferably coating or compressing EPDM rubber or silicone rubber onto the shaft 19. For example, a diameter of the second outer portion 15 may be substantially similar to a diameter of the first outer portion 11. The diameter of the second outer portion 15 preferably is a little greater than the diameter of the first outer portion 11. In this case, the diameter of the second outer portion 15 is determined considering the elastic force of the elastic element 30 and the rigidity of the elastic rubber layer 16. The elastic rubber layer 16 is compressed by the elastic force of the elastic element 30 and the pinch roller 20 contacts the first outer portion 11. Generally, a diameter difference between the first outer portion 11 and the second outer portion 15 is preferably not over about 2 mm.

According to the paper transfer unit described above, the elastic rubber layer 16 of the second outer portion 15 is compressed by the elastic element 30. When the pinch roller 20 contacts the first outer portion 11, the elastic rubber layer 16 is not compressed anymore. Accordingly, a radius of the second outer portion 15, which contacts the pinch roller 20, becomes identical with a radius R1 of the first outer portion 11 as shown in FIG. 3. When paper is lead-in between the feed roller 10 and the pinch roller 20, the paper is transferred for a distance depending on the radius R1 of the first outer portion 11 and the rotation angle θ (radian) of the feed roller 10. Since the second outer portion 15, on which the elastic rubber layer 16 is provided, has greater friction than the first outer portion 11, paper slippage is minimized. The first outer portion 11 defines a reference radius used to determine the paper transfer rate because the diameter thereof does not greatly change according to temperature changes. Consequently, the paper can be accurately transferred since it is not affected by temperature changes.

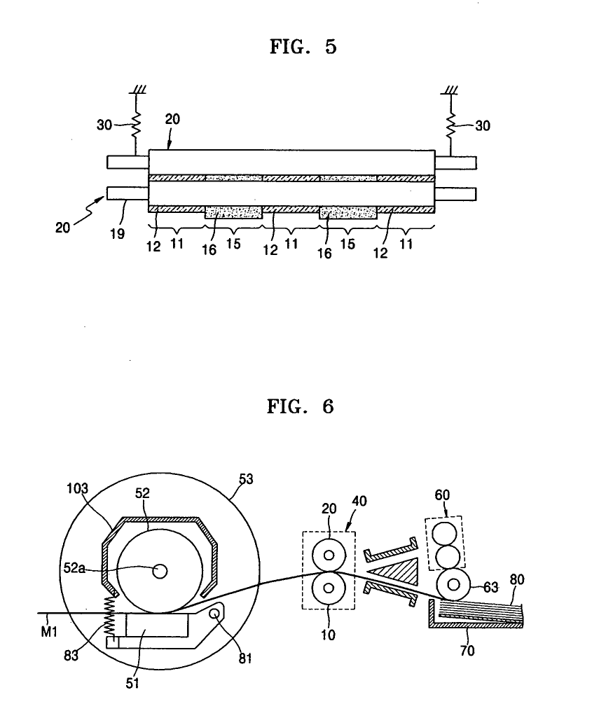

FIG. 4 is a cross-sectional view of a paper transfer unit according to another embodiment of the present invention. Referring to FIG. 4, a ceramic coating layer 12 is formed on the first outer portion 11. The first outer portion 11 has relative small frictional characteristics. The ceramic coating layer 12 increases friction of the first outer portion 11 to reduce paper slippage. Moreover, since a diameter of the ceramic coating layer 12 does not greatly change according to a temperature change, paper transfer is more accurate. Also, since the ceramic coating layer 12 has good abrasion resistance, life span of the paper transfer unit can be relatively increased. The paper transfer unit according to the embodiment of the present invention can be modified into various forms, for example, as shown in the FIG. 5.

The paper transfer unit according to the exemplary embodiments of the present invention can be applied to an image forming apparatus generating heat during a printing process, such as a thermal image forming apparatus.

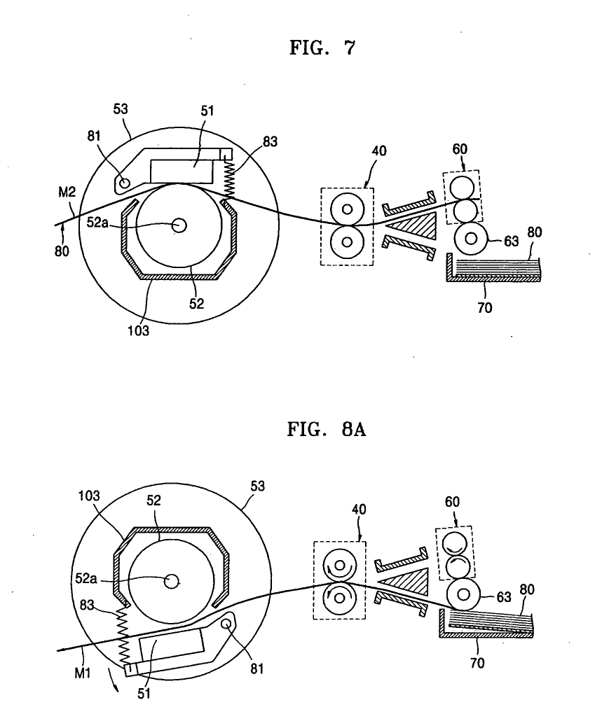

FIG. 6 is a configuration diagram schematically illustrating an image forming apparatus according to an exemplary embodiment of the present invention. The image forming apparatus is moved to a first position in which a thermal printing head (TPH) 51 faces a first surface M1 of the paper 80, as shown in FIG. 6, and to a second position in which the TPH 51 faces a second surface M2 of the paper 80, as shown in FIG. 7. The TPH 51 is rotated on a pivot 52a of a platen 52 to move to the first or second position. Also, in the image forming apparatus, the TPH 51 is arranged to elastically contact or separate from the platen 52.

A support bracket 53 is rotatably installed on the pivot 52a of the platen 52. A cover 103 covering the platen 52 is combined with the support bracket 53. The TPH 51 is combined with the support bracket 53 in order to pivot on a hinge shaft 81. An elastic element 83 such as a tensile spring is also provided. One end of the elastic element is combined with the TPH 51 and another end thereof is combined with the cover 103. A paper transfer unit 40 transfers the paper 80 at a predetermined printing speed. In order to print an image on the paper, the TPH 51 instantaneously applies heat having a temperature of more than approximately 100° C. on the paper 80. Accordingly, during a printing process, a temperature of the image forming apparatus elevates. In order to prevent a reduction of the paper transfer accuracy due to a temperature change, the paper transfer unit 40 preferably has a configuration as shown in FIGS. 2 through 5.

An example of a configuration in which the TPH 51 rotates on the pivot 52a of the platen 52 to move to the first position or the second position is disclosed in Korean Patent Application No. 2003-101583, filed on Dec. 31, 2003, and Korean Patent Application No. 2004-42504 filed on Jun. 10, 2004, the entire disclosures of which are hereby incorporated by reference. However, the technical scope of the image forming apparatus according to an exemplary embodiment of the present invention is not restricted to the configuration disclosed in the above-described applications.

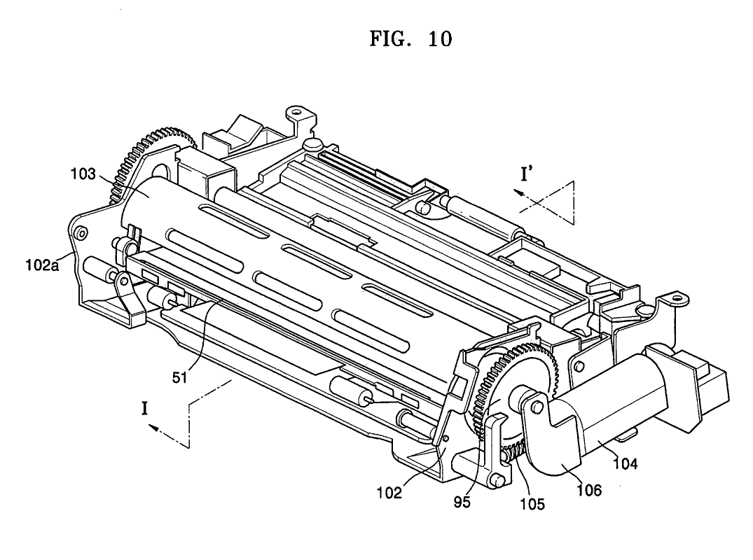

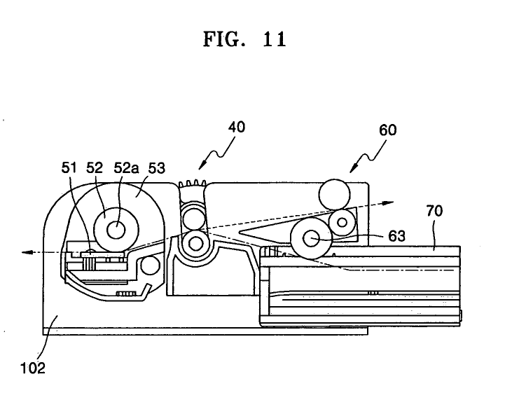

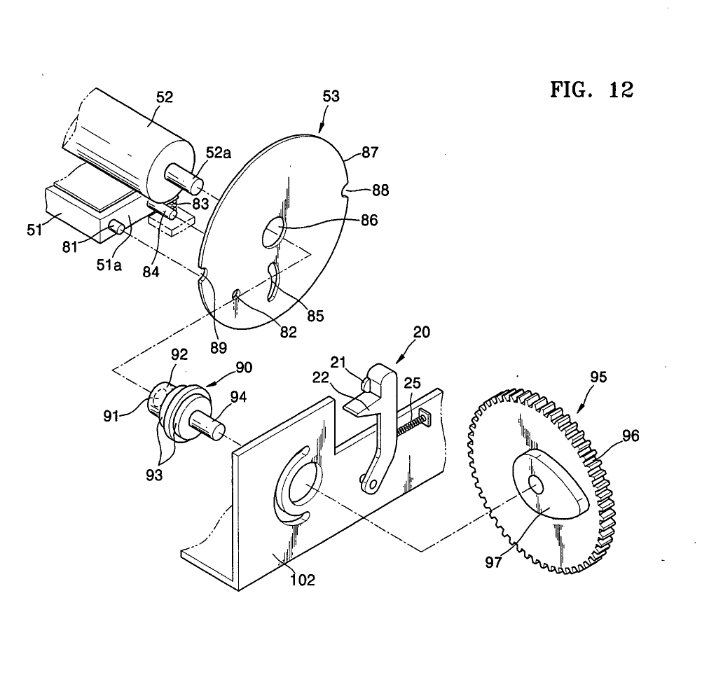

FIG. 10 is schematic perspective view of an image forming apparatus disclosed in Korean Patent Application No. 2004-42504, FIG. 11 is a cross-sectional view taken along line I-I′ of FIG. 10. FIG. 12 is an exploded perspective view illustrating in detail a rotation structure of a thermal printing head (TPH).

Referring to FIGS. 10 through 12, the hinge shaft 81 provided on a side portion 51a of the TPH 51 is inserted in a hinge hole 82 provided in the support bracket 53. The TPH 51 is combined with the support bracket 53 in order to pivot on the hinge hole 82. The TPH 51 is elastically biased toward the platen 52 by the elastic element 83 to contact the platen 52. One end of a shaft 84 is combined with the TPH 51 and another end of the shaft 84 is inserted in a through hole 85 provided in the support bracket 53. In order to allow the TPH 51 to move to contact or separate from the platen 52, the through hole 85 may have a substantially slot like shape. Since the TPH 51 in the image forming apparatus according to an embodiment of the present invention pivots on the hinge hole 82 to contact or separate from the platen 52, the through hole 85 may be a circular slot around the hinge hole 82. The platen 52 is not connected to a driving motor (not shown). The platen 52 contacts the paper 80 to be driven in accordance with paper transferring by the paper transfer unit 40. The platen 52 may be connected to a driving motor (not shown) to rotate.

A bushing 90 includes an inner circumferential portion 91 and first, second, and third outer circumferential portions 92, 93, and 94, which are concentric. The pivot 52a of the platen 52 is inserted in the inner circumferential portion 91. The first outer circumferential portion 92 is inserted in a support hole 86 provided in the support bracket 53 for rotation. A rotation cam 95 is combined with the third outer circumferential portion 94 so as to also rotate. The rotation cam 95 includes a gear portion 96 and a cam portion 97 contacting the shaft 84. A motor 104 of FIG. 10 includes a worm gear 105 engaged with the gear portion 96. A bracket 106, combined with the motor 104, is combined with a sidewall 102. The second outer circumferential portion 93 of the bushing 90 is inserted in a hole provided in the sidewall 102, and an end portion of the third outer circumferential portion 94 is supported by the bracket 106. The bracket 106 supports the rotation cam 95 to prevent separation from the third outer circumferential portion 94. In the configuration described above, the platen 52, the support bracket 53, and the rotation cam 95 have the same rotational center. The support bracket 53 has a circular circumference 87 and first and second combination holes 88 and 89, arranged about 180° from each other, are provided on the circumference 87. A locking element 20 is pivotally arranged on the sidewall 102. An elastic element 25 elastically biases the locking element 20 toward the first and second combination holes 88 and 89. The locking element 20 separates from the first and second combination holes 88 and 89 by the rotation cam 95 and is combined with the first and second combination holes 88 and 89 by the elastic element 25. The locking element 20 includes a protrusion 21 combined with the first and second combination holes 88 and 89 and an interference portion 22 interfering with the cam portion 97 of the rotation cam 95. A rotation structure, as shown in FIG. 12, may be provided on a side panel 102a.

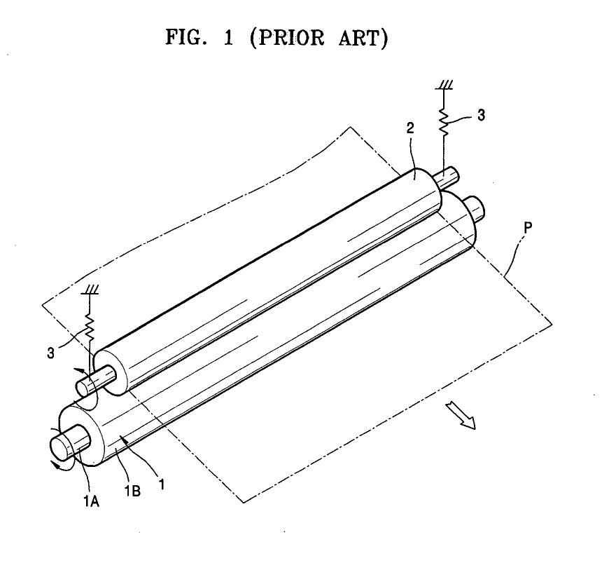

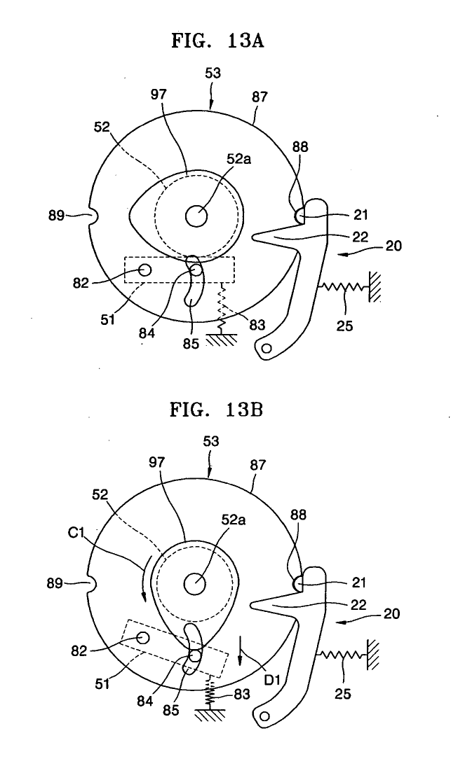

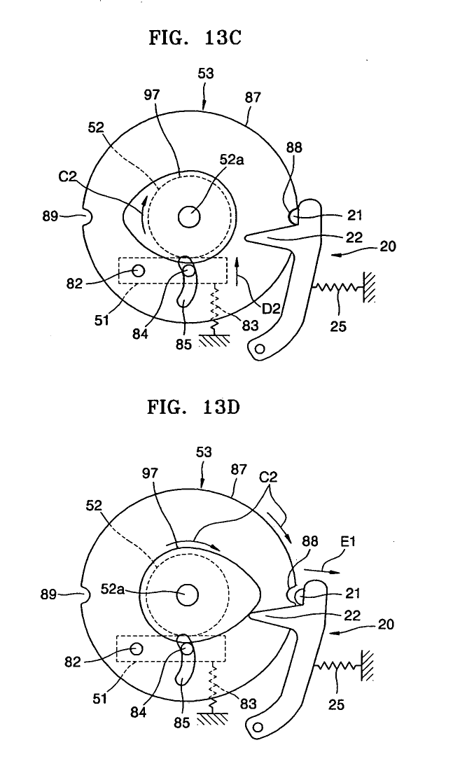

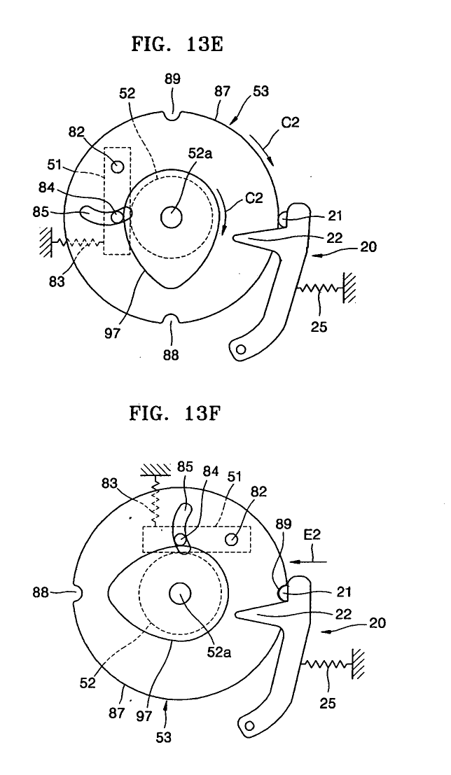

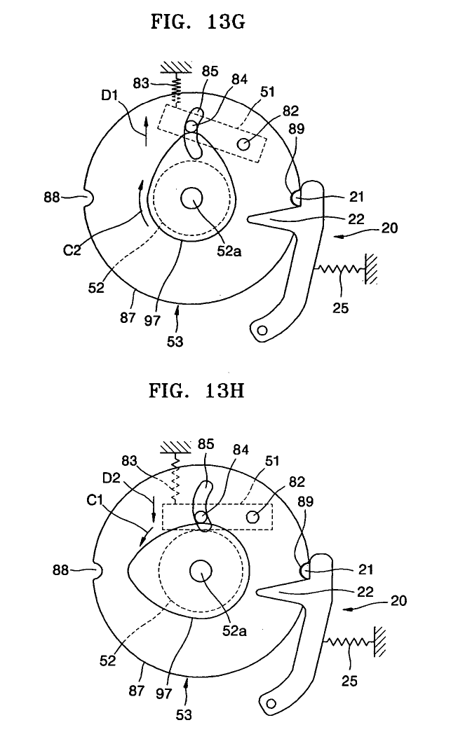

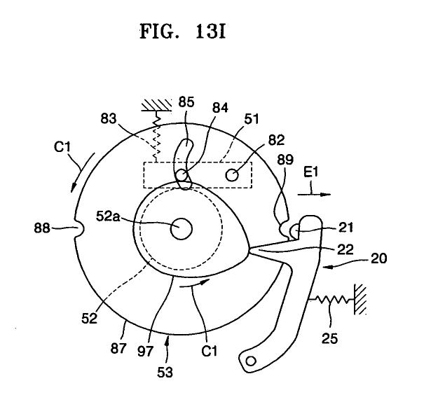

Rotating operations of the TPH 51 described above will be schematically described. Referring to FIG. 13A, the TPH 51 is in elastic contact with the platen 52. Also, since the protrusion 21 of the locking element 20 is hitched into the first combination hole 88, the TPH 51 is locked in the first position as shown in FIG. 1. Referring to FIG. 13B, the rotation cam 95 is rotated in direction C1, and the cam portion 97 pushes the shaft 84. Since the protrusion 21 of the locking element 20 is combined with the first combination hole 88, the support bracket 53 does not rotate. The shaft 84 is pushed along the through hole 85 in direction D1, and the TPH 51 pivots on the hinge hole 82 to separate from the platen 52.

Referring to FIG. 13C, the rotation cam 95 is rotated in direction C2. Since the protrusion 21 of the locking element 20 is combined with the first combination hole 88, the support bracket 53 does not rotate. The TPH 51 pivots on the hinge hole 82 in direction D2 by the elastic element 83 and approaches the platen 52.

Now, a process in which the TPH 51 is moved to the second position in which the TPH 51 faces a second surface M2 of paper 80 will be described. Referring to 13D, when the rotation cam 95 is rotated in direction C2, the cam portion 97 pushes the interference portion 22 to rotate the locking element 20 in direction E1. Then, the protrusion 21 separates from the first combination hole 88, and the support bracket 53 can rotate freely. Accordingly, when the cam portion 97 rotates continuously in the direction C2 to push the shaft 84, the TPH 51 does not depart in the direction D1, instead, the support bracket 53 rotates in the direction C2 as shown in FIG. 13E. While the support bracket 53 rotates in the direction C2, since the cam portion 97 pushes the shaft 84, the TPH 51 actually separates slightly from the platen 52. When interference between the cam portion 97 and the interference portion 22, the locking element 20 is continuously contacts the circumference 87 of the support bracket 53 via the elastic element 25. When the support bracket 53 is rotated by 180° as shown in FIG. 13F, the locking element 20 rotates in direction E2 by the elastic element 25. Then, the protrusion 21 is combined with the second combination hole 89, and the support bracket 53 is locked and does not rotate. Thereafter, as shown in FIG. 7, the TPH 51 reaches the second position in which the TPH 51 faces a second surface M2 of the paper 80.

When the rotation cam 95 continuously rotates in the direction C2, since the protrusion 21 is combined with the second combination hole 89, the support bracket 53 does not rotate. Instead, as shown in FIG. 13G, since the shaft 84 is pushed along the through hole 85, the TPH 51 separates from the platen 52.

When the rotation cam 95 rotates in the direction C1, since the protrusion 21 is combined with the second combination hole 89, the support bracket 53 does not rotate. Instead, as shown in FIG. 13H, since the shaft 84 moves backward along the through hole 85, the TPH 51 contacts the platen 52.

When printing of an image is finished, as shown in FIG. 13I, the rotation cam 95 rotates in the direction C1. The cam portion 97 pushes the interference portion 22 to rotate the locking element 20 in the direction E1. Then, the protrusion 21 separates from the second combination hole 89, and the support bracket 53 can freely rotate. When the cam portion 97 pushes the shaft 84, the support bracket 53 rotates until the protrusion 21 is combined with the first combination hole 88 by the elastic element 25. Then the TPH 51 is returned to the first position as shown in FIG. 13A. In this state or as shown in FIG. 13B, the TPH 51 separates from the platen 52 and is in a standby mode for a next printing operation.

An image forming process of the image forming apparatus according to the embodiments of the present invention will now be described.

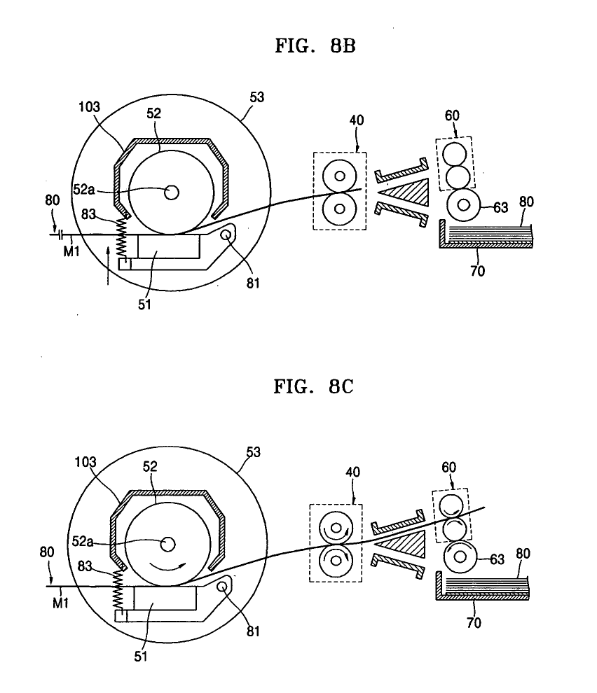

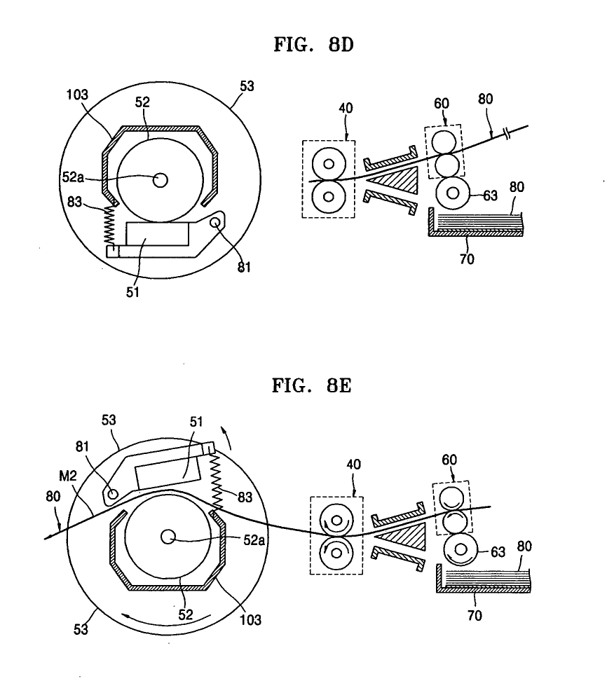

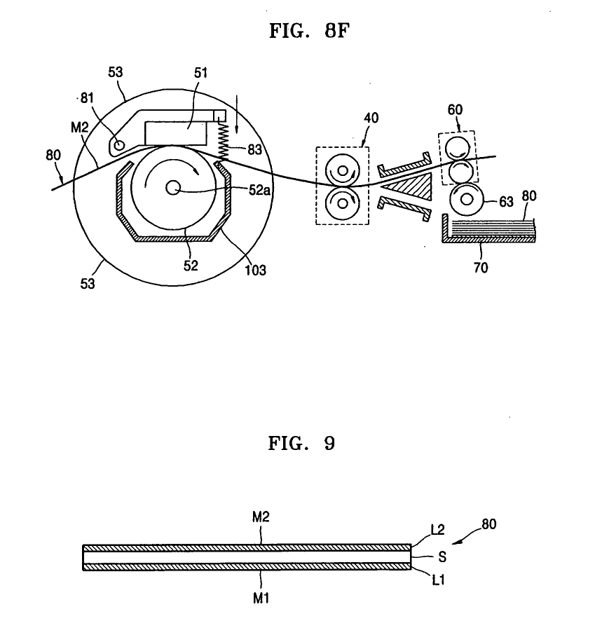

Referring to FIG. 8A, the TPH 51 is located in the first position. The paper 80 is picked up from a paper feeding cassette 70 by the pickup roller 63 and is transferred in a first direction by the paper transfer unit 40. Then, the TPH 51 separates from the platen 52 and the paper 80 is transferred between the TPH 51 and the platen 52. Referring to FIG. 8B, when the paper 80 reaches a print start position, the paper transfer unit 40 stops transferring the paper 80 and the TPH 51 approaches the platen 52. Thus, the TPH 51 contacts the first surface M1 of the paper 80.

Referring to FIG. 8C, the paper transfer unit 40 transfers the paper 80 in the second direction at a predetermined printing speed. The TPH 51 applies heat on the first surface M1 of the paper 80 to print an image and the paper 80 is discharged temporarily by an outlet 60. When the printing on the first surface M1 of the paper 80 is finished, as shown in FIG. 8D, the paper transfer unit 40 stops transferring the paper 80.

Now, the TPH 51 faces the second surface M2 of the paper 80. Referring to FIG. 8E, the TPH 51 rotates on the pivot 52a of the platen 52 and is located in the second position. In this case, the cover 103 rotates together with the TPH 51. Then, the TPH 51 separates from the platen 52 and the paper transfer unit 40 transfers the paper 80 in the first direction to locate the paper 80 in the printing start position.

Next, referring to FIG. 8F, the TPH 51 approaches the platen 52. The TPH 51 contacts the second surface M2 of the paper by the elastic element 83 and the paper transfer unit 40 transfers the paper 80 in the second direction at a predetermined speed. The TPH 51 applies heat on the second surface M2 of the paper 80 to print an image. Then, the paper with the printed image is discharged by the outlet 60.

The paper 80 may have a configuration as shown in FIG. 9. On the paper 80, ink layers L1 and L2, which react to heat and display predetermined colors, are formed on both sides of a base sheet S, namely, the first and second surfaces M1 and M2. The respective ink layers L1 and L2 may have a single layer configuration to display a single color or a multi-layer configuration to display two or more colors.

As a first example, two layers to display yellow and magenta may be provided on the ink layer L1, and a layer to display cyan may be provided on the ink layer L2. The yellow and magenta colors of ink layer L1 may be revealed selectively according to a temperature and heating time of the TPH 51. For example, when heat is applied at a high temperature for a short heating time, yellow may be revealed, and when heat is applied at a low temperature for a relatively long heating time, magenta may be revealed. Of course, the reverse is possible. If the base sheet S is a transparent material, when yellow, magenta, and cyan of the ink layers L1 and L2 are revealed respectively, the three colors overlap to display a color image. The paper 80 described above is disclosed in U.S. Patent Publication No. US2003/0125206, the entire disclosure of which is hereby incorporated by reference.

As a second example, if the base sheet S is an opaque material, different images are printed on the first and second surfaces M1 and M2 respectively. Thus, double-sided printing is possible. The technical scope of the image forming method according to an embodiment of the present invention is not restricted by the configuration of the ink layers L1 and L2 of the first and second surfaces M1 and M2 of the paper 80.

When a color image is formed by the double-sided printing employing the paper of the first example, yellow and magenta images printed on the first surface and a cyan image printed on the second surface have to be accurately overlapped. When a double-sided printing is performed employing the paper of the second example, if the paper is not transferred at a uniform speed, printed images become longer or shorter.

According to the image forming apparatus according to the present invention, by employing the paper transfer unit 40 including the first outer portion 11, which defines a reference radius used to determine the amount of paper transfer, and the second outer portion 15, which prevents paper slippage due to friction, the paper can be transferred at a uniform speed despite temperature change. Accordingly, printed images having relatively good quality can be realized.

Those skilled in the art can apply the paper transfer unit illustrated in FIGS. 2 through 5, in addition to electrophotographic image forming apparatuses, to image forming apparatuses employing different printing methods.

While the present invention has been particularly shown and described with reference to exemplary embodiments thereof, it will be understood by those of ordinary skill in the art that various changes in form and details may be made therein without departing from the spirit and scope of the exemplary embodiments of the invention as defined by the appended claims.

What is claimed is:

1. A paper transfer unit comprising:
a pinch roller;
a feed roller having a first outer portion, which defines a reference radius used to determine a paper transfer rate, and a second outer portion on which a substantially elastic rubber layer is provided; and
an elastic element which elastically biases the pinch roller and the feed roller toward each other.

2. The paper transfer unit of claim 1, wherein a diameter of the second outer portion is greater than a diameter of the first outer portion, and the elastic rubber layer is compressed by the elastic element so that the pinch roller contacts the first outer portion.

3. The paper transfer unit of claim 2, wherein a difference between the diameters of the first and second outer portions is less than or equal to about 2 mm.

4. The paper transfer unit of claim 1, wherein a ceramic coating layer is provided on the first outer portion.

5. An image forming apparatus comprising:
a paper transfer unit which transfers paper;
a thermal printing head which applies heat to the paper to form images; and
a platen pressure which presses the paper to the thermal printing head, wherein the paper transferring unit comprises:
a pinch roller;
a feed roller having a first outer portion, which defines a reference radius used to determine a paper transfer rate, and a second outer portion on which a substantially elastic rubber layer is provided; and
an elastic element which elastically biases the pinch roller and the feed roller toward each other.

6. The apparatus of claim 5, wherein a diameter of the second outer portion is greater than a diameter of the first outer portion, and the elastic rubber layer is compressed by the elastic element so that the pinch roller contacts the first outer portion.

7. The apparatus of claim 5, wherein a ceramic coating layer is provided on the first outer portion.

8. The apparatus of claim 5, wherein the thermal printing head rotates on the platen to move to a first position to face a first surface of the paper and to a second position to face a second surface of the paper.
